(19) United States
(12) Patent Application Publication
(10) Pub. No.: US 2026/0029673 A1
(43) Pub. Date: Jan. 29, 2026

(54) OPTICAL ISOLATOR PRODUCTION METHOD, OPTICAL ISOLATOR, AND POLARIZING GLASS

(71) Applicant: HOYA CORPORATION, Tokyo (JP)

(72) Inventors: Yoshiatsu YOKOO, Tokyo (JP); Yoshitaka YONEDA, Tokyo (JP)

(73) Assignee: HOYA CORPORATION, Tokyo (JP)

(21) Appl. No.: 19/343,032

(22) Filed: Sep. 29, 2025

Related U.S. Application Data
(63) Continuation of application No. PCT/JP2024/012356, filed on Mar. 27, 2024.

(30) Foreign Application Priority Data
Mar. 31, 2023 (JP) 2023-058765

(51) Int. Cl. G02F 1/09; C03C 17/36; G02F 1/01

(52) U.S. Cl. CPC G02F 1/093; C03C 17/3657; G02F 1/0102; G02F 1/0136; G02F 2201/38

(57) ABSTRACT

Provided is a method of producing an optical isolator that is thinner than conventional optical isolators but is extremely less affected by film stress in an anti-reflection film. An optical isolator production method in an embodiment is a method of producing an optical isolator including a Faraday rotator and a polarizing glass attached to the Faraday rotator, and includes the steps of bonding the polarizing glass to the Faraday rotator and forming an anti-reflection film on a surface of the bonded polarizing glass.

### CLAIM FOR PRIORITY

This application is a Continuation of PCT/JP2024/012356 filed Mar. 27, 2024, which is expressly incorporated by reference herein in its entirety.

### TECHNICAL FIELD

The present disclosure relates to subject matter contained in Japanese Patent Application No. 2023-058765 (filed on March 31, 2023) which is expressly incorporated by reference herein in its entirety.

The present invention relates to an optical isolator production method, an optical isolator, and a polarizing glass for use in an optical isolator.

### BACKGROUND ART

Heretofore, a semiconductor laser module used in optical communications, measurement, or the like uses an optical isolator in order to prevent reflected light from returning to a semiconductor laser element and causing instability in laser oscillation.

A typical optical isolator is constructed by placing a flat-plate-shaped Faraday rotator between two polarizers, and housing these three components in a cylindrical magnet. In general, the Faraday rotator is adjusted to such a thickness that the rotator can rotate the polarization plane of light in a predetermined wavelength by 45°in a saturation magnetic field, whereas rotation adjustment of the two polarizers is made such that their transmission polarization directions are shifted from each other by 45°in the rotation direction.

Furthermore, in such an optical isolator, reflected light from surfaces of a polarizer may cause noise and the like. To avoid this, a structure in which anti-reflection films are provided on the surfaces of the polarizer so that the reflectance for the wavelength band of light being used (for example, a wavelength band of 1250 to 1650 nm for use in optical communications) is equal to or lower than a predetermined value (for example, 0.3% or below) has been also provided for practical use (for example, Patent Literature 1).

Such an optical isolator is generally produced by steps of:
(1) producing polarizers (polarizing glasses);
(2) forming an anti-reflection film on one surface of each of the polarizers of the above (1), and
(3) bonding the polarizers of the above (2) to both surfaces of a Faraday rotator.

However, in the case where the anti-reflection film is formed on one surface of the polarizer, the polarizer may be warped due to film stress. This makes the work of bonding the polarizers to the Faraday rotator difficult and arouses concern about a risk that the polarizers may peel off (fall off) from the Faraday rotator.

Furthermore, in recent years, in order to miniaturize optical isolators, there has been a demand for even thinner polarizers (for example, with a thickness of 0.1 mm or less) than conventional ones. However, thinner polarizers are subject to more pronounced influence of film stress in the anti-reflection film (in other words, the amount of warping of the polarizers increases), making the bonding work more difficult and increasing the risk of the polarizers peeling off.

FIG. 3 shows results of an experiment conducted by the inventors, showing a relationship between the thickness of a polarizing glass and the amount of warping of the polarizing glass (in other words, the influence of film stress in the anti-reflection film). In this experiment, 11 mm square polarizing glass samples with different thicknesses (thicknesses: 0.1 mm, 0.12 mm, and 0.2 mm) were prepared. An anti-reflection film (film thickness: 600 nm) composed of totally eight alternating layers of Ta₂O₅ and SiO₂ was formed on one surface of each of the samples. Then, the surface roughness of each sample was measured using a measuring device (Model: Newview 8200 manufactured by Zygo), and the maximum height was taken as the amount of warping.

As shown in FIG. 3, it is seen that, as the thickness of the polarizing glass becomes thinner, the influence of the film stress in the anti-reflection film becomes non-negligible and the amount of warping increases.

To solve this problem, it has been proposed to form a warp suppression film on the other surface of a polarizer (the surface on the side opposite to the anti-reflection film) to suppress warping of the polarizer (in other words, to counteract the film stress in the anti-reflection film) (see, for example, Patent Literature 2).

### CITATION LIST

### Patent Literatures

Patent Literature 1: Japanese Patent Application Publication No. 2013-54323

Patent Literature 2: Japanese Patent Application Publication No. 2020-91443

### SUMMARY OF INVENTION

### Technical Problem

However, the structure of Patent Literature 2 has the following problems: (i) the cost increases due to the additional warp suppression film; and (ii) since there are a variation (tolerance) in the thickness of the anti-reflection film and a variation (tolerance) in the thickness of the warp suppression film, it is not possible to completely eliminate the influence of film stress (in other words, the warping of the polarizer).

The present invention has been made in view of the above circumstances, and has an object to provide a method of producing an optical isolator that is thinner than conventional ones but has a very small amount of warping of a polarizing glass, as well as to provide an optical isolator. Moreover, the present invention has an object to provide a polarizing glass for use in such an optical isolator.

### Solution to Problem

To achieve the above objects, an optical isolator production method in an embodiment is a method of producing an optical isolator including a Faraday rotator and a polarizing glass attached to the Faraday rotator, and includes the steps of bonding the polarizing glass to the Faraday rotator and forming an anti-reflection film on a surface of the bonded polarizing glass.

According to this method, the polarizing glass on which the anti-reflection film is yet to be formed is bonded to the Faraday rotator, and thereafter the anti-reflection film is formed on the surface of the polarizing glass (in other words, the polarizing glass is bonded to the Faraday rotator before warping occurs in the polarizing glass), so that the polarizing glass with almost (substantially) no warping is bonded and fixed to the Faraday rotator. Thus, the polarizing glass is firmly attached to the Faraday rotator (in other words, the risk of peeling-off is reduced).

In addition, since the polarizing glass is attached with almost no warping, the anti-reflection film functions to the maximum extent (as designed).

In addition, since the polarizing glass is attached with almost no warping, the polarizing glass may be configured to be extremely thin.

Moreover, since the anti-reflection film is formed with the polarizing glass attached to the Faraday rotator, there is no need to consider the occurrence of warping of the polarizing glass, so that an anti-reflection film having a larger thickness than those of conventional ones can be formed and the film structure and film thickness of the anti-reflection film may be changed freely depending on the specifications of the optical isolator.

The step of forming the anti-reflection film desirably includes alternately stacking a low refractive-index film having a relatively low refractive index and a high refractive-index film having a relatively high refractive index.

In addition, the film thickness of the anti-reflection film is desirably 400 to 2000 nm.

The thickness of the polarizing glass is desirably 0.028 to 0.20 mm.

The amount of warping of the bonded polarizing glass is desirably 3 μm or less.

The production method desirably further includes, after the forming of the anti-reflection film, the step of shaping the resultant intermediate product to a predetermined size.

The polarizing glass desirably includes a first polarizing glass in which a direction of a polarization axis is oriented in a direction of 0°, and a second polarizing glass in which a direction of a polarization axis is oriented in a direction of 45°, and the step of bonding the polarizing glass desirably includes bonding the first polarizing glass to one surface of the Faraday rotator and bonding the second polarizing glass to the other surface of the Faraday rotator.

From another aspect, an optical isolator in another embodiment is an optical isolator including a Faraday rotator and a polarizing glass bonded to the Faraday rotator, wherein a thickness of the polarizing glass is 0.10 mm or less, and the optical isolator includes an anti-reflection film having a thickness of 650 nm or more and formed on only an outer surface of the polarizing glass. In this case, an amount of warping of the polarizing glass is desirably 3 μm or less. Moreover, it is desirable that a functional film configured to suppress warping of the polarizing glass should not be provided on an inner surface of the polarizing glass opposed to the outer surface.

From still another aspect, a polarizing glass in an embodiment is a polarizing glass for an optical isolator, having one surface to be bonded to a Faraday rotator, wherein a thickness is 0.028 to 0.20 mm, and the polarizing glass comprises an anti-reflection film having a thickness of 400 to 2000 nm and formed on the other surface of the polarizing glass after the polarizing glass is bonded to the Faraday rotator. In this case, an amount of warping of the polarizing glass is desirably 3 μm or less.

### Advantageous Effects of Invention

As described above, according to these embodiments, it is possible to provide a method of producing an optical isolator that is thinner than conventional ones but has a very small amount of warping of a polarizing glass, as well as to realize such an optical isolator. Moreover, a polarizing glass to be used for such an optical isolator is realized.

### BRIEF DESCRIPTION OF DRAWINGS

FIGS. 1A and 1B are schematic views for explaining a structure of an optical isolator according to an embodiment to be described in the present specification.

FIG. 2 is a flowchart for explaining an optical isolator production method according to an embodiment to be described in the present specification..

FIG. 3 is a diagram presenting a relationship between a thickness of a conventional polarizing glass and an amount of warping of the polarizing glass.

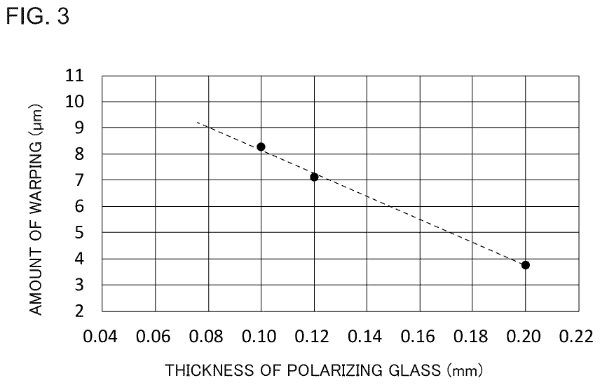

### DESCRIPTION OF EMBODIMENTS

Hereinafter, an embodiment of the present invention will be described in detail with reference to the drawings. Here, the same or equivalent portions in the drawings are assigned with the same reference signs and their repetitive explanation will be omitted.

### Structure of Optical Isolator

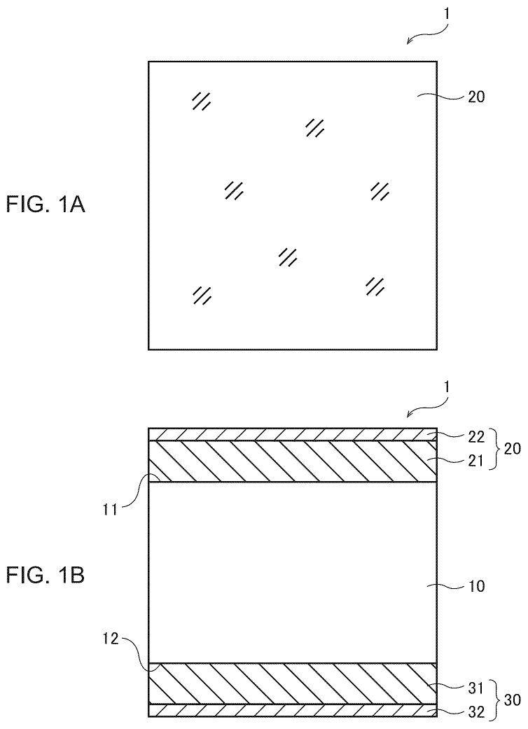

FIG. 1 includes schematic views for explaining a structure of an optical isolator 1 according to an embodiment, in which FIG. 1A is a plan view and FIG. 1B is a side cross-sectional view. As shown in FIGS. 1A and 1B, the optical isolator 1 in the present embodiment is an isolator in which a pair of polarizing elements 20 and 30 are joined to both surfaces of a Faraday rotator 10 so that the polarizing elements 20 and 30 have a common optical axis. The wavelength band in which the optical isolator 1 in the present embodiment is used is not particularly limited and the optical isolator 1 may be used for light in a wavelength band of 1250 to 1650 nm or in a wavelength band of 1650 nm or more, for example. In the present embodiment, the polarization axis of the polarizing element 20 and the polarization axis of the polarizing element 30 are inclined at 45°with respect to each other. The size of the optical isolator 1 in the present embodiment is not particularly limited and is, for example, a 0.4 to 0.7 mm square as seen from the polarizing element 20 side.

The Faraday rotator 10 is an element fabricated by forming a magneto-optical thin film (for example, a Bi-substituted magnetic garnet film) on a non-magnetic garnet substrate by a liquid phase epitaxy (LPE) method, a sputtering method, an aerosol deposition method, or the like, and has a first main surface 11 and a second main surface 12 that are opposed to each other. The refractive index of the Faraday rotator 10 in the present embodiment at 1550 nm is 2.34 and the thickness of the Faraday rotator 10 is 0.35 to 0.5 mm.

The pair of the polarizing elements 20 and 30 are optical elements respectively attached to the first main surface 11 and the second main surface 12 of the Faraday rotator 10, and each include a polarizing glass 21 or 31 and an anti-reflection film 22 or 32. In the present embodiment, the polarizing glass 21 is a polarizing glass having a polarization axis in a specific first direction (direction of 0°), whereas the polarizing glass 31 is a polarizing glass having a polarization axis in a second direction (direction of 45°) forming 45°with respect to the polarization axis of the polarizing glass 21.

As shown in FIGS. 1A and 1B, each of the polarizing glasses 21 and 31 in the present embodiment has a rectangular plate-shaped appearance (for example, 0.7 mm (widthwise)×0.7 mm (lengthwise) and a thickness: 0.028 to 0.20 mm). Metal layers (not shown) in which a large number of roughly needle-shaped metal fine particles are dispersed while being oriented in parallel are formed on both of the front and back surfaces of the polarizing glass 21 or 31 and a metal halide layer (not shown) containing metal halide fine particles is formed between the metal layers.

Each of the metal layers is a layer with a predetermined thickness (for example, 0.010 to 0.045 mm) formed by precipitating needle-shaped metal fine particles made of silver or copper in a reducing step to be described later.

The metal halide layer is a layer with a predetermined thickness (for example, 0.001 to 0.060 mm) internally formed with the formation of the metal layers in the reducing step to be described below.

Each of the anti-reflection films 22 and 32 is, for example, formed of a multilayer in which low refractive-index films having a relatively low refractive index (for example, SiO₂: a refractive index 1.46) and high refractive-index films having a relatively high refractive index (for example, Ta₂O₅: a refractive index 2.1 or TiO2: a refractive index 2.35) are alternately stacked, and is configured so that a desired distribution curve of reflectance can be obtained by selecting the thickness of each layer. In the present embodiment, the anti-reflection film 22 and the anti-reflection film 32 have the same structure, for example, an eight-layer structure with a film thickness: 400 to 800 nm, which keeps the reflectance at 0.3% or below over a wide wavelength band of 1250 to 1650 nm.

In the present embodiment, since the anti-reflection films 22 and 32 are formed on the surfaces of the polarizing glasses 21 and 31 after the polarizing glass 21 is bonded to the Faraday rotator 10 (details will be described later), no film stress is generated by the anti-reflection films 22 and 32. Therefore, the film structure and film thickness of the anti-reflection films 22 and 32 may be changed appropriately depending on the specifications of the optical isolator 1 (for example, such as the center wavelength and the bandwidth of laser light), and for example, the film thickness may be freely set within a range of 400 to 2000 nm.

### Optical Isolator Production Method

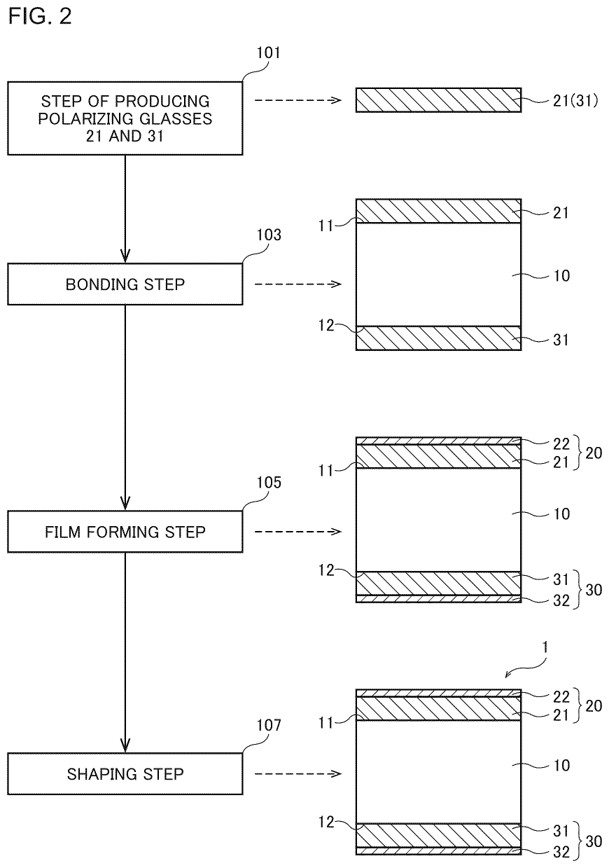

Next, a method of producing the optical isolator 1 in the present embodiment will be described. FIG. 2 is a flowchart presenting the method of producing the optical isolator 1 in the present embodiment (steps 101 to 107).

The optical isolator 1 in the present embodiment is produced according to the following procedures.
1. The polarizing glasses 21 and 31 are prepared (produced) (step of producing the polarizing glasses 21 and 31).
2. The Faraday rotator 10 is prepared and the polarizing glasses 21 and 31 are bonded to the Faraday rotator 10 (bonding step).
3. The anti-reflection films 22 and 32 are formed on the surfaces of the polarizing glasses 21 and 31, respectively (film forming step).
4. The resultant intermediate product is shaped into a predetermined size (shaping step).

Hereinafter, each of the procedures (steps) will be described in detail.

### [1. Step of Producing Polarizing Glasses 21 and 31]

The polarizing glasses 21 and 31 in the present embodiment are produced according to the following procedure.
(1) Predetermined glass materials containing copper or silver are blended in a desired composition, melted at approximately 1450° C., and then cooled slowly to room temperature (glass substrate producing step).
(2) The glass substrate is treated by heat and fine particles of cuprous chloride or silver chloride are precipitated in the glass (metal halide fine particle precipitating step)
(3) A preform having an appropriate shape (for example, 120×250×4 mm) is fabricated by machining (preform fabricating step).
(4) The preform is heated and stretched under predetermined conditions to obtain a glass sheet (for example, a width: approximately 18 mm and a thickness: approximately 0.5 mm) (glass stretching step).
(5) The glass sheet is cut and polished on both sides to fabricate double-side-polished products (for example, a 11 mm square and a thickness: 0.028 to 0.20 mm) (polished product fabricating step).
(6) The polished product is reduced in a hydrogen atmosphere (reducing step). By way of the reducing step, needle-shaped metal (copper or silver) fine particles are precipitated and metal layers (not shown) and a metal halide layer (not shown) are formed in each of the polarizing glasses 21 and 31, so that the polarizing glasses 21 and 31 are obtained (FIG. 2: step 101). As described above, the polarizing glass 21 has the polarization axis in the first direction (direction of 0°), whereas the polarizing glass 31 has the polarization axis in the second direction (direction of 45°). In the present embodiment, the thickness of the polarizing glasses 21 and 31 is within the range of 0.028 to 0.20 mm, but is not necessarily limited to this structure.

### [2. Bonding Step]

The bonding step is a step of preparing the Faraday rotator 10 and bonding the polarizing glasses 21 and 31 to the first main surface 11 and the second main surface 12 of the Faraday rotator 10, respectively. Specifically, an organic adhesive, EPO-TEK 353ND (a refractive index 1.5694 @ 589 nm) manufactured by Epoxy Technology, is applied to the first main surface 11 and the second main surface 12 of the Faraday rotator 10, and the polarizing glasses 21 and 31 are superimposed with precise positional alignment and are fixed by being cured (thermally hardened) at 150° C. for one hour (FIG. 2: step 103).

### [3. Film Forming Step]

The film forming step is a step of forming the anti-reflection films 22 and 32 on the surfaces of the bonded polarizing glasses 21 and 31, respectively. Specifically, the anti-reflection films 22 and 32 (a thickness: 400 to 800 nm) each composed of totally eight alternating layers of Ta₂O₅ and SiO₂ are formed by ion beam assisted deposition (hereinafter abbreviated as IAD) (FIG. 2: step 105). These anti-reflection films are designed to support a wideband so that a reflectance of light in a wavelength band of 1250 to 1650 nm used in optical communications is 0.3% or below.

### [4. Shaping Step]

The shaping step is a step of shaping the resultant intermediate product to a predetermined size. In the present embodiment, for example, the intermediate product is cut into, for example, a 0.4 to 0.7 mm square, thereby obtaining the optical isolator 1 in the present embodiment (FIG. 2: step 107).

In this way, the optical isolator 1 in the present embodiment is obtained by bonding the polarizing glasses 21 and 31, on which the anti-reflection films 22 and 32 are yet to be formed, to the Faraday rotator 10, and then forming the anti-reflection films 22 and 32 on the surfaces of the polarizing glasses 21 and 31.

Thus, according to the production method in the present embodiment, the polarizing glasses 21 and 31 with almost (substantially) no warping (for example, an amount of warping: 3 μm or less) are bonded and fixed to the Faraday rotator 10, so that the polarizing glasses 21 and 31 are firmly attached to the Faraday rotator 10 (in other words, the risk of peeling-off is reduced).

Furthermore, since the polarizing glasses 21 and 31 are attached with almost no warping (for example, an amount of warping: 3 μm or less), the anti-reflection films 22 and 32 function to the maximum extent (as designed).

In addition, since the polarizing glasses 21 and 31 are attached with almost no warping (for example, 3 μm or less), the polarizing glasses 21 and 31 may be configured to be extremely thin (for example, preferably 0.028 to 0.10 mm and more preferably 0.028 to 0.050 mm).

Moreover, since the anti-reflection films 22 and 32 are formed with the polarizing glasses 21 and 31 attached to the Faraday rotator 10, there is no need to consider the occurrence of warping of the polarizing glasses 21 and 31, so that anti-reflection films with a larger film thickness (for example, in a range of 400 to 2000 nm, preferably 650 to 2000 nm, and more preferably 800 to 2000 nm) than those of conventional ones can be formed. Furthermore, the film structure and film thickness of the anti-reflection films 22, 32 may be changed freely depending on the specifications of the optical isolator 1.

The above description is for explaining the embodiment of the present invention. The present invention is not limited to the structure of the aforementioned embodiment, and may be modified in various ways within the scope of the technical idea.

For example, the optical isolator 1 in the present embodiment has been described as having the pair of the polarizing elements 20 and 30, but the optical isolator 1 is not necessarily limited to this structure and may have only one of them.

In addition, in the present embodiment, the anti-reflection films 22 and 32 are formed on the surfaces of the polarizing glasses 21 and 31, but other functional films (for example, band-pass filters) may be formed instead of or in addition to the anti-reflection films.

Moreover, in the present embodiment, the shaping step is carried out after the film forming step. However, if the Faraday rotator 10 and the polarizing glasses 21 and 31 with predetermined sizes are prepared in advance, the shaping step is not necessarily required.

Note that, the embodiment disclosed herein should be considered to be exemplary and nonrestrictive in all respects. The scope of the present invention is specified not by the above description but by the scope of claims, and is intended to include all modifications within the meaning and scope equivalent to the scope of claims.

### REFERENCE SIGNS LIST

1: optical isolator
10: Faraday rotator
11: first main surface
12: second main surface
20: polarizing element
21: polarizing glass
22: anti-reflection film
30: polarizing element
31: polarizing glass
32: anti-reflection film

1. An optical isolator production method of producing an optical isolator including a Faraday rotator and a polarizing glass attached to the Faraday rotator, comprising the steps of:
bonding the polarizing glass to the Faraday rotator; and
forming an anti-reflection film on a surface of the bonded polarizing glass.

2. The optical isolator production method according to claim 1, wherein
the step of forming the anti-reflection film includes alternately stacking a low refractive-index film having a relatively low refractive index and a high refractive-index film having a relatively high refractive index.

3. The optical isolator production method according to claim 1, wherein
a film thickness of the anti-reflection film is 400 to 2000 nm.

4. The optical isolator production method according to claim 2, wherein
a film thickness of the anti-reflection film is 400 to 2000 nm.

5. The optical isolator production method according to claim 1, wherein a thickness of the polarizing glass is 0.028 to 0.20 mm.

6. The optical isolator production method according to claim 1, wherein
an amount of warping of the bonded polarizing glass is 3μm or less.

7. The optical isolator production method according to claim 1, further comprising, after the forming of the anti-reflection film, the step of shaping the resultant intermediate product to a predetermined size.

8. The optical isolator production method according to claim 1, wherein
the polarizing glass includes a first polarizing glass in which a direction of a polarization axis is oriented in a direction of 0°, and a second polarizing glass in which a direction of a polarization axis is oriented in a direction of 45°, and
the step of bonding the polarizing glass includes bonding the first polarizing glass to one surface of the Faraday rotator and bonding the second polarizing glass to the other surface of the Faraday rotator.

9. An optical isolator comprising a Faraday rotator and a polarizing glass bonded to the Faraday rotator, wherein
a thickness of the polarizing glass is 0.10 mm or less, and
the optical isolator comprises an anti-reflection film having a thickness of 650 nm or more and formed on only an outer surface of the polarizing glass.

10. The optical isolator according to claim 9, wherein an amount of warping of the polarizing glass is 3 μm or less.

11. The optical isolator according to claim 9, wherein a functional film configured to suppress warping of the polarizing glass is not provided on an inner surface of the polarizing glass opposed to the outer surface.

12. A polarizing glass for an optical isolator, having one surface to be bonded to a Faraday rotator, wherein
a thickness is 0.028 to 0.20 mm, and
the polarizing glass comprises an anti-reflection film having a thickness of 400 to 2000 nm and formed on the other surface after the polarizing glass is bonded to the Faraday rotator.

13. The polarizing glass according to claim 12, wherein an amount of warping of the polarizing glass is 3 μm or less.
